(19) United States
(12) Patent Application Publication
(10) Pub. No.: US 2019/0345426 A1
(43) Pub. Date: Nov. 14, 2019

(54) Device, System, and Method for Applying High Voltage, High Frequency Electric Field to a Beverage

(71) Applicant: Faraday, LLC, Tampa, FL (US)

(72) Inventor: Clyde Richard Snodgrass, Tampa, FL (US)

(21) Appl. No.: 16/410,339

(22) Filed: May 13, 2019

Related U.S. Application Data
(60) Provisional application No. 62/762,597, filed on May 11, 2018.

(51) Int. Cl. C12H 1/16

(52) U.S. Cl. CPC C12H 1/165

(57) ABSTRACT

The present disclosure provides a device for applying a high frequency, high voltage field to a substance, such as wine or liquor. The high voltage, high frequency field causes electrochemical reactions that change the chemical make-up of said substance. This is done by running the high voltage, high frequency field to two separately insulated electrodes that are placed parallel to each other within the device.

### CROSS-REFERENCE TO RELATED APPLICATION

This application claims the benefit of U.S. Provisional Application No. 62/762,597, filed on May 11, 2018, the disclosure of which is herein incorporated by reference.

### FIELD

The present disclosure relates to the field of applying electric fields to food or beverage to alter chemical properties thereof; and, more particularly, to a device and method for applying a high frequency, high voltage electric field to alcoholic beverages to induce chemical reactions that occur during the aging process.

### BACKGROUND

Consumption of alcohol plays a role in cultures around the world. Alcoholic beverages can be made from a variety of ingredients and though a variety of processes. In beers, wines, and spirits, ethanol is generated through anaerobic fermentation.

Fermentation is the breakdown of sugars resulting in alcohol, carbon dioxide, and other products. There are many types of alcohol made from many sugar sources. Sugar sources determine the flavor, alcohol, taste, and other properties that an alcoholic beverage will have. In addition to the variety of sugar sources, aging is also used to develop different flavor profiles and characteristics in alcoholic beverages.

The desired qualities of the finished alcoholic beverage determine how the beverage is aged. Aging may be used to acidify, deacidify, adjust color, or stabilize the alcoholic beverage. While aging is the traditional method of changing the properties and characteristic of an alcoholic beverage, these qualities are all ultimately results of chemical reactions. These reactions naturally happen very slowly, requiring years to achieve the desired results. Thus, there is a need for a device that can speed up the aging process of alcohol beverages to provide desirable flavor, smell, and mouthfeel in a shorter amount of time.

According to one or more exemplary embodiments, there is provided a device and method that produces a high frequency, high voltage electric field to induce electrochemical changes that occur during the aging of an alcoholic beverage in a shorter amount of time.

### SUMMARY

In accordance with the present disclosure, a device and method for aging alcoholic beverages is provided. The device may use a high voltage, high frequency electric field generator to increase the voltage and frequency from a main power to a level that induces electrochemical changes in alcoholic beverages.

In one exemplary embodiment, the device for applying an electric field to a beverage may comprise an adjustable regulator that receives a DC input voltage, modifies the input voltage, and outputs an adjusted DC output voltage; an H-bridge that receives the adjusted DC output voltage and generates an AC voltage signal having a predetermined frequency; a transformer that receives the AC voltage signal generated by the H-bridge, increases the AC voltage, and outputs an increased AC voltage signal having a predetermined voltage; two field plates electrically coupled to the transformer that generate an electric field between the two field plates based on the increased AC voltage signal output by the transformer; a detection circuit that detects the AC voltage signal generated by the H-bridge, and generates a DC feedback signal based on the detected AC voltage signal; and a controller that outputs a voltage control signal to the adjustable regulator based on the feedback signal; wherein the adjustable regulator outputs the adjusted DC output voltage based on the voltage control signal.

In another exemplary embodiment, the adjusted DC output voltage may be from approximately 4 V to 12 V.

In another exemplary embodiment, the increased AC voltage signal output by the transformer may be from approximately 2,000 V to 6,000 V.

In another exemplary embodiment, the device may include a frequency generator that provides a signal to the H-bridge, wherein the H-bridge generates the AC voltage signal having the predetermined frequency based on the signal received from the frequency generator.

In another exemplary embodiment, the signal provided by the frequency generator may be from approximately 1 kHz to 50 kHz.

In another exemplary embodiment, the increased AC voltage signal output by the transformer may have a voltage of approximately 2,000 V to 6,000 V at a frequency of approximately 3 kHz.

In another exemplary embodiment, the device may include an RLC circuit for damping the AC voltage signal having the predetermined frequency provided by the H-bridge to the transformer.

In another exemplary embodiment, the signal provided by the frequency generator to the H-bridge may have a frequency of approximately 3 kHz.

In another exemplary embodiment, the device may include a first transformer and a second transformer.

In another exemplary embodiment, the first transformer and the second transformer may be individually insulated.

In another exemplary embodiment, the first transformer and the second transformer may be coated with a resin.

In another exemplary embodiment, the first transformer and the second transformer may each have a turns ratio of approximately 1:500.

In another exemplary embodiment, the device may include a first regulator that converts an input AC voltage signal into the DC input voltage that is received by the adjustable regulator.

In another exemplary embodiment, the detection circuit may be comprised of a rectifier to convert the detected AC voltage into the DC feedback signal; and a voltage divider to decrease the voltage of the DC feedback signal before the DC feedback signal reaches the controller.

In another exemplary embodiment, the device may include a user interface that allows a user to control the increased AC voltage signal and the predetermined frequency.

In another exemplary embodiment, the electric field generated between the field plates is from approximately 300 V/cm to 900 V/cm.

### BRIEF DESCRIPTION OF THE DRAWINGS

FIG. 1 is a front perspective view of a device for applying a high frequency, high voltage electric field to an alcoholic beverage according to an exemplary embodiment; and

FIG. 2 is a front view of an exemplary embodiment of the device;

FIG. 3 is a diagram of the electronic components according to an exemplary embodiment of the device;

FIG. 4 is a diagram of the electrical components according to another exemplary embodiment of the device;

FIG. 5 is a diagram of a flyback regulator according to an exemplary embodiment of the device;

FIG. 6 is a diagram of an adjustable step-down regulator according to an exemplary embodiment of the device;

FIG. 7 is a diagram of a linear regulator according to an exemplary embodiment of the device.

FIG. 8 is a diagram of an H-bridge according to an exemplary embodiment of the device;

FIG. 9 is a diagram of an exemplary astable multivibrator according to an exemplary embodiment of the device;

FIG. 10 is a diagram of an exemplary series RLC circuit according to an exemplary embodiment of the device;

FIG. 11 is a diagram of a rectifier according to an exemplary embodiment of the device; and

FIG. 12 is a diagram of a voltage divider according to an exemplary embodiment of the device.

### DETAILED DESCRIPTION

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

In accordance with the present disclosure, a device utilizes an electric field generator to convert power from a residential outlet into a high frequency, high voltage electric field to induce electrochemical changes in an alcoholic beverage.

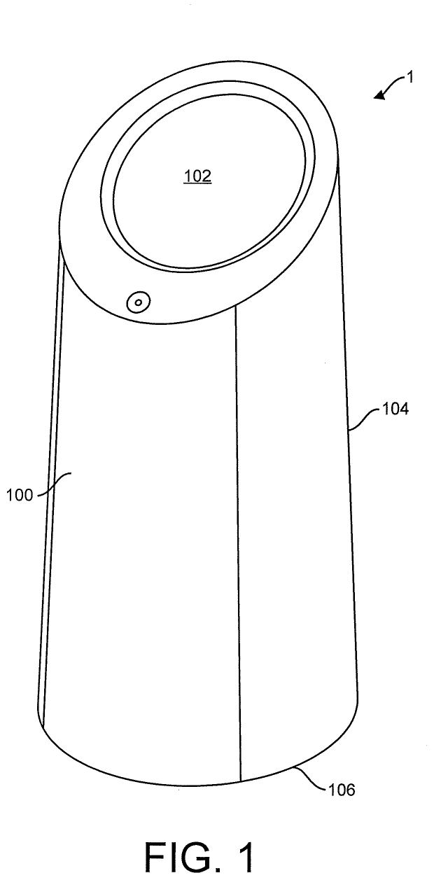

Referring to FIG. 1, a device according to the present exemplary embodiment is shown. The device 1 may include a body 100 with a cavity 102 formed by a wall 104 extending upward from an edge of a base 106. A container (not shown) may be placed in the cavity 102. In an exemplary embodiment, power is received from a power socket (not shown) and the device 1 to produce an electric field having between 200 V/cm and 1,200 V/cm. The electric field is passed across the container to produce electrochemical reactions within the liquid or beverage in the container to initiate aging reactions in a shorter amount of time. In one exemplary embodiment, the voltage used to generate the electric field produced by the device can be anywhere from 2,000 to 6,000 V peak to peak but is not limited thereto; and the frequency of the voltage used to generate the electric field may be from about 1,000 Hz to 50,000 Hz. According to one exemplary embodiment, the voltage used to create the electric field may be 3000 V at a frequency of 3000 Hz.

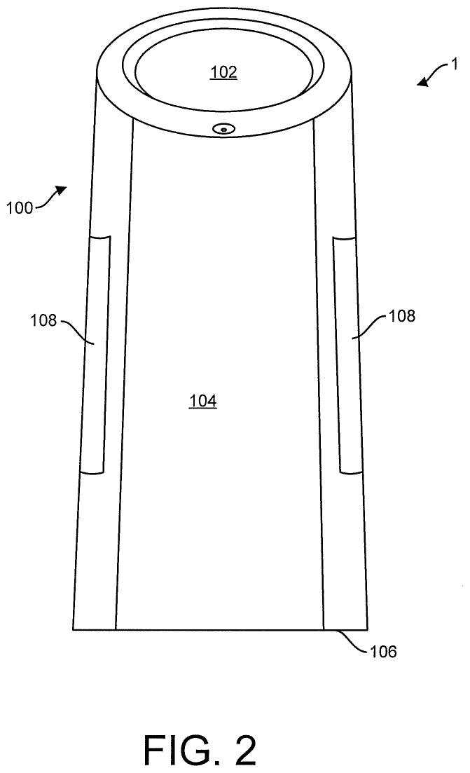

Referring to FIG. 2, a front view of an exemplary embodiment of the device 1 showing the location of electrodes or field plates 108 within the wall 104. In some embodiments, the electrodes or field plates 108 are located within the wall 108 such that the field plates 108 are on opposite sides of the cavity 102. In some exemplary embodiments, the field plates 108 may be spaced approximately 5 cm to 20 cm apart. Then, the high frequency, high voltage signal is applied to the electrodes or field plates 108 resulting in an electric field being passed through the container when the container is located between the electrodes or field plates 108. In one exemplary embodiment, the field plates 108 may be 10 cm apart and the voltage used to produce the electric field is 6,000 V AC at a frequency of 3,000 Hz. In another embodiment, the electric field across the field plates 108 is 600 V/cm.

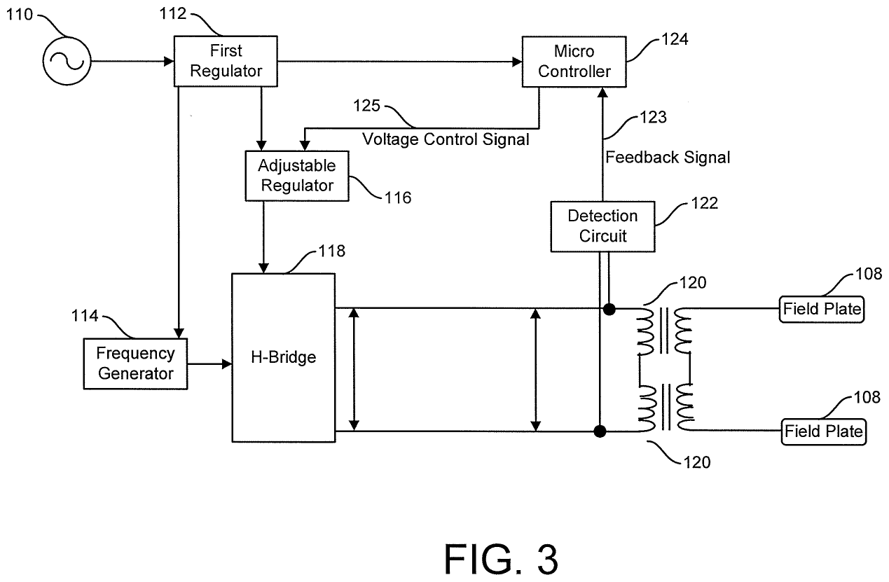

Referring now to FIG. 3, a diagram of the electrical components of one exemplary embodiment of the device is shown. In this exemplary embodiment, the device 1 includes a first regulator 112, a frequency generator 114, an adjustable regulator 116, an H-bridge 118, at least one transformer 120, a detection circuit 122, two field plates 108, and a controller 124.

In this embodiment, the first regulator 112 receives power from a power source 110, for example, a standard 120 V, 60 Hz power source. The first regulator 112 may be a voltage regulator that steps down the voltage from the power source 110 and converts the AC voltage from the power source 110 into DC voltage to power the frequency generator 114, the adjustable regulator 116, and the controller 124. The first regulator 112, may be a flyback regulator or a buck-boost convertor. By way of example, the first regulator 112 may take the standard voltage supplied by an outlet in a home, which is approximately 80 to 250 VAC, and convert that to a DC voltage from about 1 V to 20 V.

The adjustable regulator 116 provides power to the H-bridge 118. The adjustable regulator 116 may adjust the power provided to the H-bridge 118 to maintain the proper voltage output at the field plates 108. The output of the adjustable regulator 116 may be adjusted in response to a voltage control signal 125 generated by the controller 124. The voltage control signal 125 is determined by the controller 124 in response to feedback from the detection circuit 122.

The detection circuit 122 may monitor the voltage provided to the transformer 120 or the voltage provided to the field plates 108. If the detection circuit 122 detects the voltage is below a predetermined value, the controller 124 increases the voltage of the voltage control signal 125, which will increase the voltage output of the adjustable regulator 116. If the detection circuit 122 detects the voltage is above a predetermined value, the controller 124 will decrease the voltage of the voltage control signal 125, which will decrease the voltage output of the adjustable regulator 116. By way of example, in an exemplary embodiment, the range of voltage provided by the adjustable regulator 116 to the H-bridge 118 may be from about 4 V to 12 V DC.

The frequency generator 114 provides a high frequency signal to the H-bridge 118. In an exemplary embodiment, the frequency generator 114 may be a timing circuit and the frequency of the signal produced may be from about 1 kHz to about 30 kHz. The H-bridge 118 converts the DC voltage provided by the adjustable regulator 116 to AC voltage. For example, the H-bridge 118 may output an AC voltage signal of 4 to 12 V at approximately 3,000 Hz. The now AC voltage is stepped up to a high voltage by the transformer 120. When the high-voltage field is active, the voltage provided to the transformers is continuously read by the detection circuit 122 which send a feedback signal 123 to the controller 124. The controller 124 then adjusts the voltage control signal 125 to the adjustable regulator 116 to maintain the desired field strength at the field plates 108.

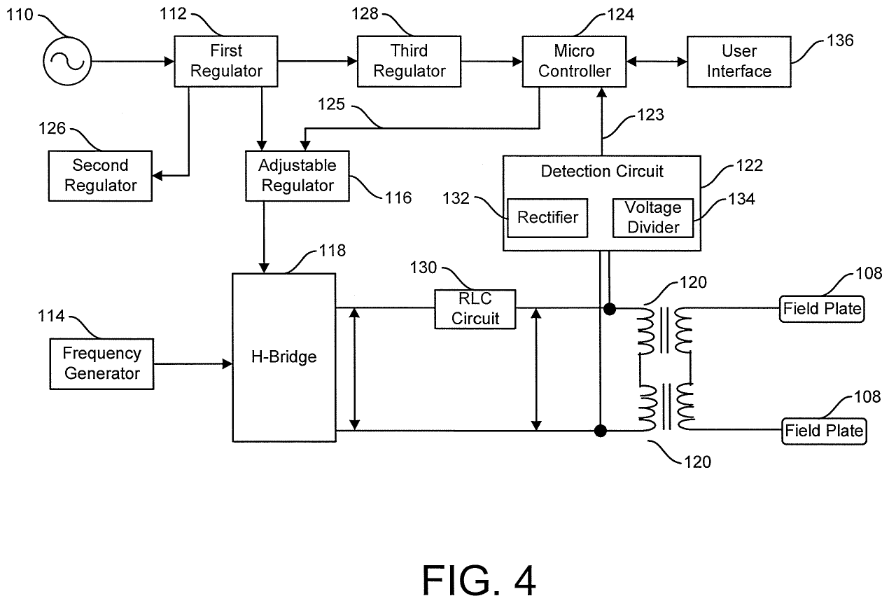

Referring now to FIG. 4, a diagram of the electrical components of another exemplary embodiment of the device is shown. The device 1 of this embodiment includes a first regulator 112, a second regulator 126, a third regulator 128, a frequency generator 114, an adjustable regulator 116, an H-bridge 118, two transformers 120, a detection circuit 122, two field plates 108, and a controller 124.

In this exemplary embodiment, AC voltage is provided by the power source 110 to the first regulator 112. The first regulator 112 steps down the voltage of the power source 110 and converts it from AC to DC. The lower DC voltage is then supplied to the second regulator 126, the third regulator 128, and the adjustable regulator 116. By way of example, the first regulator 112 may take the standard voltage supplied by an outlet in a home, which is approximately 250 VAC, and convert that to a DC voltage from about 10 V to 20 V.

The second regulator 126 steps down the voltage from the first regulator 112 before sending power to the frequency generator 114. By way of example, if the first regulator 112 outputs a DC voltage of 16 V, the second regulator 126 may step that down to 12 VDC to power the frequency generator 114.

The third regulator 128 steps down the voltage from the first regulator 112 before sending power to the controller 124. By way of example, if the first regulator 112 outputs a DC voltage of 16 V, the third regulator 128 may step that down to approximately 1 to 5 VDC to power the controller 124.

The adjustable regulator 116 steps down the voltage received from the first regulator 112 and provides the stepped down voltage to the H-Bridge 118. For example, the adjustable regulator 116 may output a voltage from about 4 V to about 12 V. The output voltage is controlled by the controller 124 in response to feedback from the detection circuit 122.

The H-bridge 118 receives the high frequency from the frequency generator 114 and the output voltage from the adjustable regulator 116. The H-bridge 118 converts the DC voltage to AC voltage resulting in a high frequency, low voltage AC voltage signal to send to the transformers 120. The transformers 120 then increase the voltage received from the H-bridge to approximately 2,000 to 6,000 VAC. The high frequency, high voltage power is applied to the field plates 108 to generate the electric field applied to a container in the cavity. According to an exemplary embodiment, each of the transformers 120 may have a turns ratio of 1:500, but are not limited to this ratio.

In an exemplary embodiment, the transformers 120 may be potted in a resin to insulate the transformers 120.

In one exemplary embodiment, the device 1 may also include an RLC circuit 130. The RLC circuit 130 converts a square output wave from the H-bridge 118 to a sine wave before the voltage is increased by the transformers 120.

In one exemplary embodiment, the detection circuit 122 is comprised of a rectifier 132 and a voltage divider 134.

In one exemplary embodiment, the device 1 includes a user interface 136. The user interface 136 may control the amount of time that the high frequency, high voltage field is applied, the voltage output that is applied, or the frequency of the field based on input received from the user. For example, the user may input instructions regarding simulated aging of the beverage. The user interface 136 may output a signal to the controller 124 based on the input received from the user. The controller 124 may modify the voltage control signal 125 based on the signal received from the user interface 136.

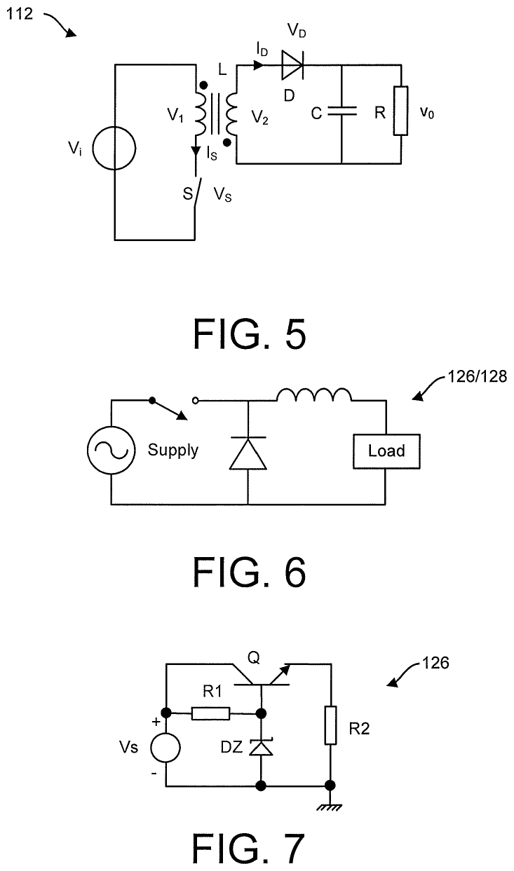

In some embodiments, the first regulator 112 may be a flyback converter. Referring now to FIG. 5, a diagram of a flyback, or buck-boost, converter according to an exemplary embodiment is shown. A flyback converter is used in both AC/DC and DC/DC conversion with galvanic isolation between the input Vᵢ and any outputs Vₒ. In an exemplary embodiment, the first regulator 112 is a buck-boost converter with the inductor L split to form a transformer, so that the voltage ratios are multiplied with an additional advantage of isolation. In such embodiments, the first regulator 112 decreases the voltage received from the power source 110 before providing the decreased voltage to one or more of the adjustable regulator 116, the second regulator 126, the third regulator 128, the frequency generator 118, and/or the controller 124.

In some embodiments, the adjustable regulator 116, the second regulator 126, and/or the third regulator 128 may be step-down regulators. Referring now to FIG. 6, a diagram of a step-down regulator according to an exemplary embodiment is shown. A step-down regulator is a buck converter that steps down voltage (while stepping up current) from its input (supply) to its output (load). It is a class of switched-mode power supply (SMPS) typically containing at least two semiconductors and at least one energy storage element.

In some embodiments, the second regulator 126 may be a linear regulator. A linear regulator is a system used to maintain a steady voltage. The resistance of the regulator varies in accordance with the load resulting in a constant output voltage. The regulating device is made to act like a variable resistor, continuously adjusting a voltage divider network to maintain a constant output voltage and continually dissipating the difference between the input and regulated voltages. FIG. 7 shows a diagram of a linear regulator according to an exemplary embodiment. The load current is supplied by the transistor Q whose base is connected to the Zener diode ZD. Thus, the transistor's base current forms the load current for the Zener diode ZD and is much smaller than the current through resistor R₂.

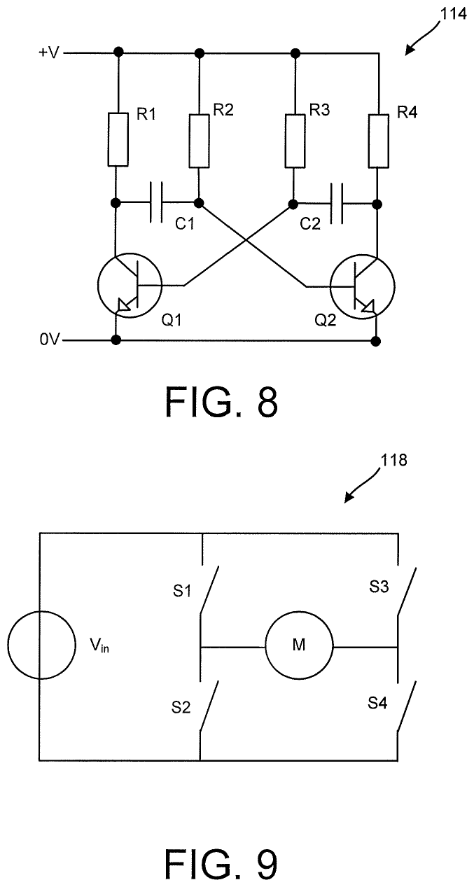

In some embodiments, the frequency generator 114 may be an astable multivibrator. FIG. 8 shows a diagram of an astable multivibrator according to an exemplary embodiment. An astable multivibrator consists of two amplifying stages connected in a positive feedback loop by two capacitive-resistive coupling networks. The amplifying elements may be junction or field-effect transistors, vacuum tubes, operational amplifiers, or other types of amplifier. The astable multivibrator has two unstable states that change alternatively with maximum transition rate because of the “accelerating” positive feedback. It is implemented by the coupling capacitors that instantly transfer voltage changes because the voltage across a capacitor cannot suddenly change. In each state, one transistor is switched on and the other is switched off. Accordingly, one fully charged capacitor discharges (reverse charges) slowly thus converting the time into an exponentially changing voltage. At the same time, the other empty capacitor quickly charges thus restoring its charge (the first capacitor acts as a time-setting capacitor and the second prepares to play this role in the next state). The circuit operation is based on the fact that the forward-biased base-emitter junction of the switched-on bipolar transistor can provide a path for the capacitor restoration.

FIG. 9 shows a diagram of an H-bridge 118 according to an exemplary embodiment. An H-bridge 118 switches the polarity of a voltage applied to a load. When switches S1 and S4 are closed (and S2 and S3 are open) a positive voltage will be applied across the motor M. By opening S1 and S4 switches and closing S2 and S3 switches, this voltage is reversed, allowing reverse operation of the motor M.

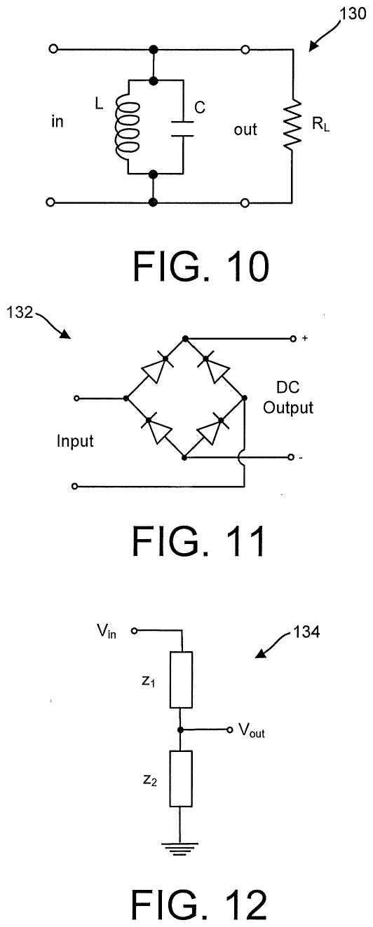

FIG. 10 shows a diagram of an RLC circuit 130 according to an exemplary embodiment of the device. The RLC circuit 130 may be used in some embodiments to convert the square wave produced by the H-bridge 118 into a sine wave. An RLC circuit 130 is an electrical circuit consisting of a resistor (R), an inductor (L), and a capacitor (C), connected in series or in parallel. An RLC circuit 130 forms a harmonic oscillator for current which smooths a square wave into a sine wave. Additionally, an RLC circuit 130 may be used as filters to provide desired frequencies. An RLC circuit 130 may be arranged to create a band-pass filter, a band-stop filter, a low-pass filter, or a high-pass filter. The RLC circuit 130 shown in FIG. 10 is a band-pass filter having a parallel LC circuit in parallel with the load resistor R. A band-pass RLC circuit may also be created by placing a series LC circuit in series with the load resister.

In some embodiments, the detection circuit 122 may be comprised of a rectifier 132 and a voltage divider 134. In such an embodiment, the AC signal generated by the H-bridge 118 is converted to DC by the rectifier 132, then the voltage divider 134 decreases the voltage being sent to the controller 124. When the controller 124 receives the feedback signal 123 from the detection circuit 122, the controller 124 sends the voltage control signal 125 to the adjustable regulator 116 to increase or decrease the voltage provided to the H-bridge 118.

FIG. 11 shows a diagram of a rectifier 132 according to an exemplary embodiment. A rectifier 132 is an electrical device that converts AC to DC so that the feedback sent to the controller 124 is in DC form. Some exemplary rectifiers are vacuum tube diodes, mercury-arc valves, stacks of copper and selenium oxide plates, semiconductor diodes, silicon-controlled rectifiers and other silicon-based semiconductor switches.

FIG. 12 is a diagram of a voltage divider 134. A voltage divider is a passive linear circuit that produces an output voltage Vₒᵤₜ that is a fraction of its input voltage Vᵢₙ. Voltage division is the result of distributing the input voltage among the components of the divider. A simple example of a voltage divider is two resistors Z₁ and Z₂ connected in series, with the input voltage Vᵢₙ applied across the resistor pair and the output voltage Vₒᵤₜ emerging from the connection between them.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A device for applying an electric field to a beverage, the device comprising:
an adjustable regulator that receives a DC input voltage, modifies the input voltage, and outputs an adjusted DC output voltage;
an H-bridge that receives the adjusted DC output voltage and generates an AC voltage signal having a predetermined frequency;
a transformer that receives the AC voltage signal generated by the H-bridge, increases the AC voltage, and outputs an increased AC voltage signal having a predetermined voltage;
two field plates electrically coupled to the transformer that generate an electric field between the two field plates based on the increased AC voltage signal output by the transformer;
a detection circuit that detects the AC voltage signal generated by the H-bridge, and generates a feedback signal based on the detected AC voltage signal; and
a controller that outputs a voltage control signal to the adjustable regulator based on the feedback signal;
wherein the adjustable regulator outputs the adjusted DC output voltage based on the voltage control signal.

2. The device according to claim 1, wherein the adjusted DC output voltage is from approximately 4 V to 12 V.

3. The device according to claim 1, wherein the increased AC voltage signal output by the transformer is from approximately 2,000 V to 6,000 V.

4. The device according to claim 1, further comprising a frequency generator that provides a signal to the H-bridge, wherein the H-bridge generates the AC voltage signal having the predetermined frequency based on the signal received from the frequency generator.

5. The device according to claim 4, wherein the signal provided by the frequency generator is from approximately 1 kHz to 50 kHz.

6. The device according to claim 4, wherein the increased AC voltage signal output by the transformer has a voltage of approximately 2,000 V to 6,000 V at a frequency of approximately 3 kHz.

7. The device according to claim 4, further comprising an RLC circuit, the RLC circuit damping the AC voltage signal having the predetermined frequency provided by the H-bridge to the transformer.

8. The device according to claim 4, wherein the signal provided by the frequency generator to the H-bridge has a frequency of approximately 3 kHz.

9. The device according to claim 1, wherein the transformer comprises a first transformer and a second transformer.

10. The device according to claim 9, wherein the first transformer and the second transformer are individually insulated.

11. The device according to claim 9, wherein the first transformer and the second transformer are coated with a resin.

12. The device according to claim 9, wherein the first transformer and the second transformer each have a turns ratio of approximately 1:500.

13. The device according to claim 1, further comprising a first regulator that converts an input AC voltage signal into the DC input voltage that is received by the adjustable regulator.

14. The device according to claim 1, wherein the detection circuit comprises:
a rectifier that converts the detected AC voltage into DC to generate the feedback signal; and
a voltage divider that divides the voltage of the feedback signal before the controller receives the feedback signal.

15. The device according to claim 1, further comprising a user interface configured to receive instructions regarding applying the electric field to the beverage, wherein the user interface is configured to transmit a signal to the controller based on the received instructions.

16. The device according to claim 1, wherein the electric field generated between the field plates is from approximately 300 V/cm to 900 V/cm.

17. The device according to claim 1, wherein the electric field generated between the field plates is 600 V/cm.
